(19) United States
(12) Patent Application Publication
(10) Pub. No.: US 2025/0296445 A1
(43) Pub. Date: Sep. 25, 2025

(54) Method and Device for Monitoring an Electric Drive of a Motor Vehicle

(71) Applicant: Bayerische Motoren Werke Aktiengesellschaft, Muenchen (DE)

(72) Inventors: Johannes ALBRECHT, Muenchen (DE); Nick BURMESTER, Duesseldorf (DE); Jovan KNEZEVIC, Muenchen (DE); Roman NESTLINGER, Muenchen (DE)

(21) Appl. No.: 18/863,728

(22) PCT Filed: Jul. 4, 2023
(86) PCT No.: PCT/EP2023/068308

§ 371 Date: Nov. 7, 2024

(30) Foreign Application Priority Data
Jul. 29, 2022 (DE) 10 2022 119 059.5

(51) Int. Cl. B60L 3/00; B60L 15/20

(52) U.S. Cl. CPC B60L 3/0084; B60L 3/0038; B60L 15/20; B60L 2240/42; B60L 2250/16; B60L 2260/44

(57) ABSTRACT

A device for monitoring an electric drive of a motor vehicle, wherein the drive comprises an electric drive machine and a control system for controlling the drive machine, and the control system comprises a pilot controller and a controller. The device is configured to determine, on the basis of a control component for controlling the drive machine determined by the control system, that there is a pilot control error situation related to the control of the drive machine. The device is further configured to take, in response to the identified pilot control error situation, at least one measure relating to the identified pilot control error situation.

### BACKGROUND AND SUMMARY

The invention relates to a method and a corresponding device that are designed to monitor the operation of an electrical drive machine of a motor vehicle.

An at least partially electrically driven vehicle encompasses an electrical drive machine for driving the vehicle, e.g. a current-excited or permanent-magnet synchronous machine. The drive machine can be driven by a control arrangement in order to cause the drive machine to provide a specific drive torque.

During the operation of the drive machine, errors and/or changes in the drive machine can occur that can impair the performance of the drive machine.

The present document is concerned with the technical problem of providing a method and a corresponding device that permit efficient and reliable monitoring and/or diagnosis of an electrical drive machine of a vehicle, in particular in order to ensure constantly high performance from the drive machine.

The problem is solved by each of the independent claims. Advantageous embodiments are described in the dependent claims, inter alia. It is pointed out that additional features of a patent claim dependent on an independent patent claim without the features of the independent patent claim or only in combination with a subset of the features of the independent patent claim can form a dedicated invention which is independent of the combination of all features of the independent patent claim and which can be made the subject of an independent claim, of a divisional application or of a subsequent application. This is applicable in the same way to technical teachings which are described in the description and which can form an invention independent of the features of the independent patent claims.

According to one aspect, a device for monitoring an electric drive of a motor vehicle is described. The drive encompasses an electrical drive machine and a control arrangement for controlling the drive machine. The control arrangement (which is arranged e.g. in a control unit of the vehicle) comprises pilot control and closed-loop control.

The control arrangement can encompass a pilot control unit for determining a pilot control portion of a value of a manipulated variable (in particular of the stator voltage) for the stator of the drive machine. The pilot control unit can determine the pilot control portion by using a model of the drive containing one or more model parameters. The parameter values of the one or more model parameters may have been determined and stored in advance of the working mode of the drive (for instance during an end-of-line test in the course of assembly of the motor vehicle).

The one or more model parameters can encompass: an angular offset θ_{off} of an angular position sensor of the rotor of the drive machine; a magnetic flux Ψ_{PM} produced by the rotor; and/or a gain factor of a current sensor for acquiring the actual value of the stator current of the drive machine (the stator current being the control variable of the control arrangement).

The model used by the pilot control unit can encompass a model in the d-q coordinate system. This can result in the angular offset θ_{off} of the angular position sensor of the rotor of the drive machine being used for transforming one or more model parameters and/or one or more (voltage and/or current) signals (for instance the stator voltage and/or the stator current) into the d-q coordinate system. An erroneous angular offset θ_{off} can therefore lead to an erroneous pilot control portion.

An illustrative model for determining the pilot control portion of the value of the manipulated variable (in particular of the stator voltage) is

$${u}_{d \_ FF} = {Ri}_{d} - {ω}_{e} \cdot {L}_{q} \cdot {i}_{q}$$

$${u}_{q \_ FF} = {Ri}_{q} + {ω}_{e} \cdot ( {Ψ}_{PM} + {L}_{d} \cdot {i}_{d} )$$

Here,
u_{d_FF} and u_{q_FF} are the pilot control portions of the stator voltages in the d-q coordinate system (as manipulated variables);
i_{q} and i_{d} are the values of the stator currents in the d-q coordinate system (as control variables);
ωₑ is the angular velocity of the rotor;
L_{q} and L_{d} are the inductances of the stator windings in the d-q coordinate system; and
R is the nonreactive resistance of the stator windings.

The control arrangement can furthermore encompass a controller (in particular a PI controller) that is configured to take a control error between the actual value (measured by the current sensor) of the control variable (in particular of the stator current of the stator of the drive machine) and the setpoint value of the control variable (in particular of the stator current) as a basis for determining the controller portion of the value of the manipulated variable (in particular of the stator voltage) for the stator of the drive machine. The setpoint value can be predetermined e.g. by the driver or by an automated driving function of the vehicle.

The pilot control portion and the controller portion can be added in order to determine the value of the manipulated variable. The drive machine can then be operated using the determined value of the manipulated variable.

The device is configured so as (during the working mode of the vehicle) to take the controller portion for controlling the drive machine that has been determined by the control arrangement as a basis for ascertaining that there is a pilot-control error situation during the control (in particular during the pilot control) of the drive machine. It is therefore possible during the working mode of the vehicle to take the controller portion as a basis for identifying that there is an error situation during the pilot control of the drive machine.

The device may be configured to ascertain that the drive machine has (consistently) been operated in a steady-state mode during an observation period. The observation period can have e.g. a length of one second or more, in particular of 5 seconds or more. It is therefore possible to identify an observation period in which the drive machine is operated in the steady-state mode (meaning that the controller portion should be zero, at least on average over time, if the model used by the pilot control is correct).

The device may furthermore be configured to identify that the absolute value of the controller portion was greater than a predefined controller threshold value, in particular on average over time, during the observation period. This can then be efficiently and reliably taken as a basis for ascertaining that there is a pilot-control error situation during the control of the drive machine.

The device is furthermore configured to respond to the identified pilot-control error situation by instigating at least one measure regarding the identified pilot-control error situation and/or regarding the electric drive. The measure instigated may be e.g. that advice that the vehicle should be serviced is output (using the user interface of the vehicle) to the user of the vehicle. As part of the servicing, a set of tests for checking the electric drive can then be performed.

Alternatively or additionally, the measures instigated may be that a set, in particular a succession or sequence, of tests for checking the electric drive, in particular for checking the model used by the pilot control unit, is performed directly (directly by the vehicle). The set of tests may be designed to check and if necessary update parameter values of one or more model parameters of the model used by the pilot control unit. The set of tests can be performed efficiently and conveniently during the working mode of the vehicle.

The device may be configured to use a user interface (of the vehicle) to inform the user of the vehicle that the set of tests is being instigated (during the working mode of the vehicle). If necessary, the user can be asked to transfer the vehicle to a defined condition, e.g. to a standstill, in order to perform the set of tests. Alternatively or additionally, it may be identified during the working mode of the vehicle that the vehicle is in a condition that is suitable for performing the set of tests (without the user having been asked to do anything in that regard). This allows the set of tests to be performed in a particularly reliable manner.

Alternatively or additionally, the device may be configured to take a result of the set of tests as a basis for ascertaining that there is a servicing situation pertaining to the drive of the vehicle (e.g. if it is identified that the pilot-control error situation cannot be remedied even by updating the parameter values of the one or more model parameters). The user of the vehicle can then be informed, using the user interface, that there is a servicing situation pertaining to the drive of the vehicle.

A device is therefore described that is designed to identify an error situation pertaining to the drive (in particular pertaining to the pilot control of the drive) during the working mode of the vehicle, and to respond thereto by performing a set of tests for checking the drive, the set of tests possibly permitting the error situation to be remedied automatically. This permits particularly convenient and reliable operation of an electric drive of a motor vehicle.

As already outlined earlier on, the device may be configured to use the set of tests to check and/or if necessary update parameter values for the one or more model parameters. The pilot control unit can then subsequently be operated using the one or more updated parameter values. This allows the reliability of the electric drive to be increased further.

The set of tests can encompass a defined succession of tests. The set of tests can encompass e.g. a high frequency signal injection, HFSI, test. Alternatively or additionally, the set of tests can encompass a flux test that is instigated in particular (directly) subsequently to the HFSI test. Alternatively or additionally, the set of tests can encompass a sensor test that is instigated in particular (directly) subsequently to the flux test.

The device may be configured to conduct the HFSI test by producing a stator current having a (relatively high) measurement frequency, and to take the injected stator current as a basis for determining (and if necessary updating) a value of the angular offset θ_{off} of the angular position sensor of the rotor of the drive machine. The HFSI test can optionally be performed while the vehicle is at a standstill (e.g. when the vehicle is standing at a red traffic light). The measurement frequency may be above the operating frequency of the stator current, which operating frequency is used to operate the drive machine, by a factor of 2 or more, or of 5 or more, or of 10 or more. The operating frequency of the stator current may be dependent on the desired speed of travel of the vehicle and/or on the desired speed of the drive machine.

The device may be configured to conduct the flux test by setting the stator current through the stator of the drive machine to zero while the drive machine is at a non-zero speed. A value of the stator voltage on the stator of the drive machine can then be acquired, and the value of the stator voltage can be taken as a basis for determining and if necessary updating the value of the magnetic flux Ψ_{PM} produced by the rotor of the drive machine.

The device may be configured to conduct the sensor test by setting the stator current through the stator of the drive machine to a defined (constant) value not equal to zero. A value of the stator voltage on the stator of the drive machine can then be acquired. The value of the stator voltage and the defined value of the stator current can then be taken as a basis for determining and if necessary updating the value of a gain factor of the current sensor for acquiring the actual value of the stator current.

The aforementioned tests allow the parameter values of one or more model parameters of the model of the drive to be checked and if necessary updated efficiently and precisely in order to automatically remedy the identified pilot-control error situation.

According to another aspect, a (road) motor vehicle (in particular an automobile or a truck or a bus or a motorcycle) is described that encompasses the device described in this document.

According to another aspect, a method for monitoring an electric drive of a motor vehicle is described. The drive encompasses an electrical drive machine and a control arrangement for controlling the drive machine. The control arrangement comprises pilot control and closed-loop control (for setting a manipulated variable, for instance the stator voltage).

The method encompasses ascertaining, on the basis of the controller portion for controlling the drive machine that has been determined by the control arrangement, that there is a pilot-control error situation during the control (in particular during the pilot control) of the drive machine. The method further encompasses instigating, in response to the identified pilot-control error situation, at least one measure, in particular a set of tests, for checking the electric drive.

A result of the set of tests can then be taken as a basis for instigating one or more measures, in particular in order to remedy the pilot-control error situation. By way of example, the parameter values of one or more model parameters of the model used in the pilot control can be updated on the basis of the result of the set of tests in order to remedy the pilot-control error situation.

According to another aspect, a software (SW) program is described. The SW program can be configured to be executed on a processor (e.g. on a control unit of a vehicle) and to thereby carry out the method described in this document.

According to another aspect, a storage medium is described. The storage medium can encompass an SW program that is configured to be executed on a processor and to thereby carry out the method described in this document.

It should be noted that the methods, devices and systems described in this document can be used either alone or in combination with other methods, devices and systems described in this document. In addition, any aspects of the methods, devices and systems described in this document can be combined with one another in various ways. In particular, the features of the claims can be combined with one another in various ways. Furthermore, features cited in brackets should be understood as optional features.

The invention is described in more detail hereinbelow on the basis of exemplary embodiments.

### BRIEF DESCRIPTION OF THE DRAWINGS

FIG. 1 shows illustrative components of a vehicle;

FIG. 2 shows an illustrative control arrangement for open-loop and/or closed-loop control of an electrical drive machine; and

FIG. 3 shows a flowchart for an illustrative method for monitoring an electrical drive machine of a vehicle.

### DETAILED DESCRIPTION OF THE DRAWINGS

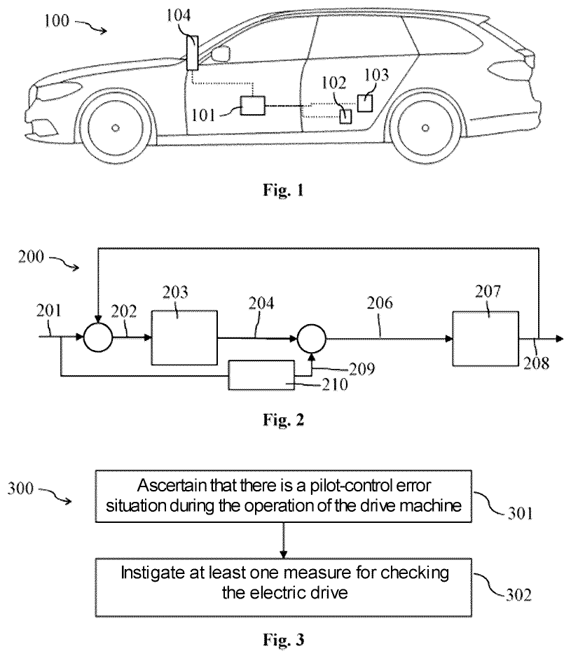

As outlined in the introduction, the present document is concerned with the efficient and reliable monitoring of an electrical drive machine of a motor vehicle. In this regard, FIG. 1 shows an illustrative vehicle 100 having an electrical drive machine 103 that is configured to drive the vehicle 100. The vehicle 100 further encompasses a (control) device 101 that is configured to control the drive machine 103, e.g. to cause the drive machine 103 to provide a drive torque that is requested by the driver of the vehicle 100 by way of the gas pedal (not depicted) of the vehicle 100.

The vehicle 100 further encompasses one or more sensors 102 that are configured to acquire sensor data regarding the electrical drive machine 103, in particular regarding the stator current of the stator of the drive machine 103. In addition, the vehicle 100 can encompass a user interface 104 for interacting with the driver of the vehicle 100.

FIG. 2 shows an illustrative control arrangement 200 for controlling the drive machine 103 (which may be e.g. part of the control device 101). The control arrangement 200 encompasses a control loop containing a controller 203 and containing a pilot control unit 210. Setpoint values 201 for one or more control variables can be predetermined. By way of example, the driver of the vehicle 100 can predetermine a specific value of the drive torque to be set, and this can be taken as a basis for determining setpoint values 201 for the one or more control variables (e.g. for the stator current through the one or more turns of the stator of the drive machine 103).

The pilot control unit 210 may be configured to take the setpoint values 201 for the one or more control variables as a basis for determining pilot control values 209 for one or more manipulated variables (e.g. for the stator voltage on the one or more stator turns of the stator). For this purpose, the pilot control unit 210 can use a model of the drive machine 103, the model having one or more model parameters. The parameter values of the one or more model parameters can be determined in advance (e.g. as part of an end-of-line (EOL) test).

The drive machine 103 can be controlled in the d-q coordinate system on the basis of the following model:

$${u}_{d} = R {i}_{d} + {L}_{d} \frac{d {i}_{d}}{d t} - {ω}_{e} \cdot {L}_{q} \cdot {i}_{q}$$

$${u}_{q} = R {i}_{q} + {L}_{q} \frac{{di}_{q}}{d t} + {ω}_{e} ( {Ψ}_{P M} + {L}_{d} \cdot {i}_{d} )$$

Here,
u_{d} and u_{q} are the stator voltages in the d-q coordinate system (as manipulated variables);
i_{q} and i_{d} are the stator currents in the d-q coordinate system (as control variables);
L_{q} and L_{d} are the inductances of the stator windings in the d-q coordinate system;
R is the nonreactive resistance of the stator windings;
ωₑ is the angular velocity of the rotor; and/or
Ψ_{PM} is the magnetic flux produced by the rotor.

The current control of the drive machine 103 can be made up of a controller portion 204 and a pilot control portion 209, and so for the stator voltages u_{d} and u_{q} it holds that:

$${u}_{d} = {u}_{d \_ FF} + {u}_{d \_ PI}$$

$${u}_{q} = {u}_{q \_ FF} + {u}_{q \_ PI}$$

where
u_{d_FF} and u_{q_FF} are the pilot control portions 209 of the stator voltages; and
u_{d_P1} and u_{q_P1} are the controller portions 204 of the stator voltages.

The pilot control unit 210 may be configured to take the setpoint values 201 for the stator currents i_{q} and i_{d} as a basis for determining the pilot control portions 209 of the stator voltages. The aforementioned model for the drive machine 103 can be used in this case, e.g.

$${u}_{d \_ FF} = {Ri}_{d} - {ω}_{e} \cdot {L}_{q} \cdot {i}_{q}$$

$${u}_{q \_ FF} = {Ri}_{q} + {ω}_{e} \cdot ( {Ψ}_{PM} + {L}_{d} \cdot {i}_{d} )$$

The controller portions 204 can be determined from the control error 202 on the basis of a controller 203, e.g. on the basis of a PI controller, the control error 202 corresponding to the difference between the setpoint value 201 of the one or more control variables and the actual value 208 of the one or more control variables (e.g. of the stator currents). The sum of the respective controller portion 204 and the respective pilot control portion 209 then results in the values 206 of the one or more manipulated variables (e.g. of the stator voltages). These are converted into the actual values 208 of the one or more control variables by the system 207 to be controlled (i.e. by the drive machine 103).

In the steady-state mode of the drive machine 103, i.e. when the setpoint value 201 of the one or more control variables is constant, the controller portion 204 should be zero, at least on average over time, over an observation period. If, on the other hand, a controller portion 204 that systematically deviates from zero is obtained in the steady-state mode, this can be an indication of an impairment of the electrical drive machine 103 and/or of the control arrangement 200. Illustrative impairments are
a deviation of the angular offset θ_{off} of the angular position sensor of the rotor from the originally measured angular offset;
an imprecise or erroneous parameter value of a model parameter of the model of the drive machine 103 that is used for the pilot control; and/or
an impairment of the current sensors 102 for acquiring the stator currents (e.g. a deviation regarding a gain factor used by a current sensor 102).

The (control) device 101 may therefore be configured to take the controller portion 204 of the control arrangement 200 as a basis for detecting a pilot-control error situation in which the pilot control portion 209 of the control arrangement 200 has a systematic error (which is compensated for by the controller portion 204 if necessary). In response thereto, a set of tests can be instigated in order to check the drive machine 103 and if necessary remedy the pilot-control error situation.

The set of tests can encompass a so-called HFSI (High Frequency Signal Injection) test in which a current having a relatively high (measurement) frequency is injected into one or both axes of the d-q coordinate system. The HFSI test can be taken as a basis for determining the correct value of the angular offset θ_{off} of the angular position sensor of the rotor. The HFSI test can be performed when the drive machine 103 is in a steady-state operating condition, in particular when the vehicle 100 is at a standstill. For this purpose, it is possible e.g. to wait for the vehicle 100 to come to a standstill (for instance at a red traffic light) in order to perform the HFSI test.

A first test can therefore be used to determine the correct value of the angular offset θ_{off} of the angular position sensor of the rotor. This value can then be transferred to the model for the drive machine 103. In particular, the transformation of one or more model parameters and/or of one or more (voltage and/or current) signals (for instance the stator voltage and/or the stator current) into the d-q coordinate system can be performed on the basis of the correct value of the angular offset θ_{off}.

A further (subsequent) test can be used to determine the magnetic flux Ψ_{PM} of the rotor. For this purpose, the stator currents i_{q} and i_{d} can be set to zero and/or interrupted. This can be achieved by transferring the inverter for producing the stator currents to a so-called freewheeling condition.

The resultant stator voltages can then be measured in order to take

u_{q}=ωₑΨ_{PM}
as a basis for determining the magnetic flux Ψ_{PM}. If there is a resultant deviation in relation to the stored value of the magnetic flux, the corrected value of the magnetic flux can be included in the model of the drive machine 103.

A further (subsequent) test can be used to check whether the current sensors 102 for measuring the actual value 208 of the stator currents are impaired (e.g. have a changed gain value or gain factor). For this purpose, each of the stator currents can be set to a defined value (at a standstill or at a specific speed of travel). The values of the stator voltages can then be determined, in particular measured or estimated on the basis of a model. Constant currents result in

$${u}_{d} = {Ri}_{d} - {ω}_{e} \cdot {L}_{q} \cdot {i}_{q}$$

$${u}_{q} = {Ri}_{q} + {ω}_{e} ( {Ψ}_{PM} + {L}_{d} \cdot {i}_{d} )$$

If it is assumed that the parameters of the electrical drive machine 103 R, L_{q} and L_{d} have not changed, the aforementioned equations can be taken as a basis for determining and updating gain factors for the current sensors 102 for measuring the currents i_{q} and i_{d}.

The set of tests can therefore be used to update the calibration of the parameter values of one or more model parameters of the model for the pilot control of the electrical machine 103. This allows the quality of control of the electrical machine 103 to be increased.

If the set of tests results in update of the parameter values not being possible, the user interface 104 can be used, if necessary, to output advice to the driver of the vehicle 100 to prompt the driver to drive the vehicle 100 to a garage.

The set of tests can be performed during operation of the vehicle 100. This can result in the user interface 104 being used, if necessary, to advise the driver that a set of tests is being performed. If necessary, the driver can be asked to transfer the vehicle 100 to a defined condition (e.g. standstill) in order to perform the set of tests. This permits a convenient and safe check on the control of the electrical drive machine 103.

FIG. 3 shows a flowchart for a (possibly computer-implemented) method 300 for monitoring an electric drive of a motor vehicle 100. The drive encompasses an electrical drive machine 103 and a control arrangement 200 for controlling the drive machine 103. The control arrangement 200 in this case comprises pilot control and closed-loop control. In particular, the control arrangement 200 can encompass a pilot control unit 210 that is configured to determine (on the basis of the setpoint value 201 of a control variable, for instance of the stator current) a pilot control portion 209 of the value 206 of the manipulated variable (for instance of the stator voltage). In addition, the control arrangement 200 can encompass a controller 203 that is configured to take the setpoint value 201 and the measured actual value 208 of the control variable as a basis for determining a controller portion 204 of the value 206 of the manipulated variable.

The method 300 encompasses determining 301, on the basis of the controller portion 204 for controlling the drive machine 103 that has been determined by the control arrangement 200, that there is a pilot-control error situation during the control (in particular during the pilot control) of the drive machine 103. In other words, the controller portion 204 can be analyzed in order to identify that the pilot control of the drive machine 103 is erroneous. For this purpose, the (possibly cumulated) controller portion 204 can be determined during an observation period in which the drive machine 103 has (consistently) been in a steady-state condition. If the pilot control is error-free, the controller portion 204 should be zero (at least on average over time) during the observation period. A non-zero controller portion 204 is an indication of erroneous pilot control, i.e. of a pilot-control error situation.

The method 300 further encompasses instigating 302, in response to the identified pilot control error situation, at least one measure for checking the electric drive. In particular, the measure instigated can be a set of tests for checking the electric drive. In particular a succession of tests, for instance an HFSI test, followed by a flux test and if necessary followed by a sensor test, can be performed in this case. The set of tests can be taken as a basis for checking and if necessary updating the parameter values of one or more model parameters of the pilot control unit 210 in order to remedy the pilot control error situation. If the pilot control error situation can be remedied, the electric drive can directly continue to be operated. On the other hand, the driver of the vehicle 100 can be asked to have the vehicle 100 serviced.

The measures described in this document permit convenient, efficient and reliable diagnosis of an electric drive of a motor vehicle 100.

The present invention is not restricted to the exemplary embodiments shown. In particular, it should be borne in mind that the description and the figures are intended to illustrate the principle of the proposed methods, devices and systems only by way of example.

1-11. (canceled)

12. A device for monitoring an electric drive of a motor vehicle, wherein the electric drive includes an electrical drive machine and a control arrangement configured to control the drive machine, wherein the control arrangement comprises pilot control and closed-loop control,
wherein the device is configured to:
ascertain, on a basis of a controller portion for controlling the drive machine that has been determined by the control arrangement, that a pilot-control error situation exists during the control of the drive machine; and
respond to the ascertained pilot-control error situation by instigating at least one measure regarding the ascertained pilot-control error situation.

13. The device according to claim 12, wherein the device is configured to:
ascertain that the drive machine has been operated in a steady-state mode during an observation period;
ascertain that an absolute value of the controller portion was greater than a controller threshold value on average over time during the observation period; and
ascertain, on a basis of the absolute value of the controller portion being greater than the controller threshold value on average over time during the observation period, that the pilot-control error situation exists during the control of the drive machine.

14. The device according to claim 12, wherein
the control arrangement comprises a pilot control unit configured to determine a pilot control portion for controlling the drive machine,
the pilot control unit is configured to determine the pilot control portion by using a model of the drive containing one or more model parameters, and
the device is configured to use a set of tests to check and/or update parameter values for the one or more model parameters.

15. The device according to claim 14, wherein the one or more model parameters comprise:
an angular offset θ_{off} of an angular position sensor of a rotor of the drive machine;
a magnetic flux Ψ_{PM} produced by the rotor; and/or
a gain factor of a current sensor for acquiring an actual value of a stator current of the drive machine.

16. The device according to claim 12, wherein the at least one measure comprises:
outputting advice to a user of the vehicle; and/or
instigating a set of tests for checking the electric drive.

17. The device according to claim 16, wherein
the set of tests encompasses a high frequency signal injection (HFSI) test, and
the device is configured to conduct the HFSI test by producing a stator current having a measurement frequency, and to take the injected stator current as a basis for determining a value of an angular offset θ_{off} of an angular position sensor of a rotor of the drive machine.

18. The device according to claim 16, wherein
the set of tests encompasses a flux test that is instigated in particular subsequently to a high frequency signal injection (HFSI) test, and
the device is configured to conduct the flux test by:
setting a stator current through a stator of the drive machine to zero while the drive machine is at a non-zero speed;
determining a value of a stator voltage on the stator of the drive machine; and
taking the value of the stator voltage as a basis for determining a value of a magnetic flux Ψ_{PM} produced by a rotor of the drive machine.

19. The device according to claim 16, wherein
the set of tests encompasses a sensor test that is instigated in particular subsequently to a flux test, and
the device is configured to conduct the sensor test by:
setting a stator current through a stator of the drive machine to a defined value not equal to zero;
determining a value of a stator voltage on the stator of the drive machine; and
taking the value of the stator voltage and the defined value of the stator current as a basis for determining a value of a gain factor of a current sensor for acquiring an actual value of the stator current.

20. The device according to claim 16, wherein
the device is configured to instigate the set of tests during a working mode of the vehicle; and/or
the device is configured to use a user interface to:
inform a user of the vehicle that the set of tests is being instigated; and/or
ask the user to transfer the vehicle to a defined condition in order to perform the set of tests; and/or
wherein the device is configured to:
take a result of the set of tests as a basis for ascertaining that there is a servicing situation pertaining to the drive of the vehicle; and
respond to ascertaining that there is a servicing situation by using the user interface to inform the user of the vehicle that the servicing situation exists.

21. The device according to claim 12, wherein
the control arrangement comprises a pilot control unit configured to determine a pilot control portion of a value of a stator voltage for a stator of the drive machine; and
the control arrangement comprises a controller that is configured to take a control error between an actual value of a stator current of the stator of the drive machine and a setpoint value of the stator current as a basis for determining the controller portion of the value of the stator voltage for the stator of the drive machine.

22. A method for monitoring an electric drive of a motor vehicle, wherein the drive comprises an electrical drive machine and a control arrangement for controlling the drive machine, wherein the control arrangement comprises pilot control and closed-loop control, the method comprising:
ascertaining, on a basis of a controller portion for controlling the drive machine that has been determined by the control arrangement, that a pilot-control error situation exists during control of the drive machine; and
instigating, in response to the ascertained pilot-control error situation, at least one measure regarding the ascertained pilot-control error situation.

23. The method according to claim 22, comprising:
ascertaining that the drive machine has been operated in a steady-state mode during an observation period;
ascertaining that an absolute value of the controller portion was greater than a controller threshold value on average over time during the observation period; and
ascertaining, on a basis of the absolute value of the controller portion being greater than the controller threshold value on average over time during the observation period, that the pilot-control error situation exists during the control of the drive machine.

24. The method according to claim 22, comprising:
determining, by a pilot control unit of the control arrangement, the pilot control portion for controlling the drive machine by using a model of the drive containing one or more model parameters; and
using a set of tests to check and/or update parameter values for the one or more model parameters.

25. The method according to claim 24, wherein the one or more model parameters comprise:
an angular offset θ_{off} of an angular position sensor of a rotor of the drive machine;
a magnetic flux Ψ_{PM} produced by the rotor; and/or
a gain factor of a current sensor for acquiring an actual value of a stator current of the drive machine.

26. The method according to claim 22,
wherein instigating the at least one measure comprises
outputting advice to a user of the vehicle; and/or
instigating a set of tests for checking the electric drive.

27. The method according to claim 26, wherein
the set of tests encompasses a high frequency signal injection (HFSI) test, and
wherein the method comprises conducting the HFSI test by producing a stator current having a measurement frequency, and taking the injected stator current as a basis for determining a value of an angular offset θ_{off} of an angular position sensor of a rotor of the drive machine.

28. The method according to claim 26, wherein
the set of tests encompasses a flux test that is instigated in particular subsequently to a high frequency signal injection (HFSI) test, and
wherein the method comprises conducting the flux test by:
setting a stator current through a stator of the drive machine to zero while the drive machine is at a non-zero speed;
determining a value of a stator voltage on the stator of the drive machine; and
taking the value of the stator voltage as a basis for determining a value of a magnetic flux Ψ_{PM} produced by a rotor of the drive machine.

29. The method according to claim 26, wherein
the set of tests encompasses a sensor test that is instigated in particular subsequently to a flux test, and
wherein the method comprises conducting the sensor test by:
setting a stator current through a stator of the drive machine to a defined value not equal to zero;
determining a value of a stator voltage on the stator of the drive machine; and
taking the value of the stator voltage and the defined value of the stator current as a basis for determining a value of a gain factor of a current sensor for acquiring an actual value of the stator current.

30. The method according to claim 26,
wherein the method comprises:
instigating the set of tests during a working mode of the vehicle; and/or
using a user interface to:
inform a user of the vehicle that the set of tests is being instigated; and/or
ask the user to transfer the vehicle to a defined condition in order to perform the set of tests; and/or
wherein the method comprises:
taking a result of the set of tests as a basis for ascertaining that there is a servicing situation pertaining to the drive of the vehicle; and
responding to ascertaining that there is a servicing situation by using the user interface to inform the user of the vehicle that the servicing situation exists.

31. The method according to claim 22, comprising:
determining, by a pilot control unit, a pilot control portion of a value of a stator voltage for a stator of the drive machine; and
taking a control error between an actual value of a stator current of the stator of the drive machine and a setpoint value of the stator current as a basis for determining the controller portion of the value of the stator voltage for the stator of the drive machine.
